(19) United States
(12) Patent Application Publication
(10) Pub. No.: US 2009/0154855 A1
(43) Pub. Date: Jun. 18, 2009

(54) WHEEL BEARING APPARATUS FOR A VEHICLE

(75) Inventor: Kouji KAMETAKA, Iwata-Shi (JP)

Correspondence Address: HARNESS, DICKEY & PIERCE, P.L.C., P.O. BOX 828, BLOOMFIELD HILLS, MI, 48303, US

(73) Assignee: NTN Corporation, Osaka (JP)

(21) Appl. No.: 12/371,728

(22) Filed: Feb. 16, 2009

Related U.S. Application Data
(63) Continuation of application No. PCT/JP2007/000848, filed on Aug. 17, 2007.

(30) Foreign Application Priority Data
Aug. 17, 2006 (JP) 2006-222347

(51) Int. Cl. F16C 33/76

(52) U.S. Cl. 384/485

(57) ABSTRACT

A wheel bearing apparatus has a wheel hub (4) formed on its one end with a wheel mounting flange (6). Its outer circumference includes one inner raceway surface (4a). A seal (11) has an integrally formed side lip (18a) extending radially outwardly toward its tip and in sliding contact with an inner side base portion (6c) of the wheel mounting flange (6), via a predetermined interference. An initial maximum diameter of the side lip (18a) is formed with a smaller diameter than that of a maximum diameter of the seal (11). A difference (e) between the initial maximum diameter of the side lip (18a) and the maximum diameter of the seal (11) is set at least 1 mm on one side (i.e. radius). The seal (11) is stably press-fit into the outer member (2) without interfering with the side lip 18a. The seal keeps a predetermined resisting force against the push out force, to improve the sealability and durability of the seal and thus extends the life of the bearing apparatus.

### CROSS-REFERENCE TO RELATED APPLICATIONS

This application is a continuation of International Application No. PCT/JP2007/000848, filed Aug. 7, 2007, which claims priority to Japanese Application No. 2006-222347, filed Aug. 17, 2006. The disclosures of the above applications are incorporated herein by reference.

### FIELD

The present disclosure relates to a wheel bearing apparatus to freely rotationally support a wheel of a vehicle, such as an automobile, relative to a suspension apparatus and, more particularly, to a wheel bearing apparatus intended to extend its life by improving the sealability and durability of the seals mounted on the wheel bearing apparatus.

### BACKGROUND

Wheel bearing apparatus to support a wheel of a vehicle that is freely rotational is supported by a wheel hub, for mounting the wheel, via a double row rolling bearing. There are two mounting types, those for a driving wheel and those for a driven wheel. For structural reasons, the inner ring rotation type is used for the driving wheel type and both the inner ring rotation type and the outer ring rotation type are used for driven wheel types. There are four generation types of wheel bearing apparatus. The first generation type has a wheel bearing including a double row angular contact ball bearing, etc. that is fit between a knuckle forming part of a suspension apparatus and a wheel hub. The second generation type has a body mounting flange or a wheel mounting flange that is directly formed on the outer circumference of an outer member. The third generation type has one inner raceway surface directly formed on the outer circumference of a wheel hub. The fourth generation type has inner raceway surfaces formed on the outer circumferences, respectively, of a wheel hub and an outer joint member.

In the bearing portion, seals are mounted to prevent leakage of lubricating grease sealed within the bearing and the entering of rain water or dusts into the bearing from the outside. Recently, maintenance free ideas have been adopted in automobiles. Thus, it is desired to further extend the operational life of the wheel bearing apparatus. Under the circumstances, it is found, after verification of damages of recovered bearings, that the main causes of damage to the wheel bearings are due to sealing defects rather than peeling of structural elements of the bearing. Accordingly, the operational life of the bearing can be extended by improving the sealability and durability of the bearing seals.

Various seals have been proposed to improve the sealability, one example of such a seal is shown in FIG. 4. The seal 50 is adapted to be mounted between an outer ring 51, formed with an outer raceway surface 51a on its inner circumference, and a wheel hub 52, formed with an inner raceway surface 52a opposing the outer raceway surface 51a. The seal 50 fills an outer end opening between the inner circumference of the outer ring 51 and the outer circumference of the wheel hub 52. The seal 50 has a metal core 53 made of a mild metal sheet adapted to be fit into the inner circumference of the outer ring 51. A sealing member 54, made of elastomer member such as rubber, is adhered to the metal core 53. The sealing member 54 includes three concentric sealing lips, a side lip 55, a dust lip 56 and a grease lip 57.

The side lip 55, arranged radially outermost of three sealing lips 55, 56, 57, is formed so that it extends radially outwardly toward its tip. The tip is adapted to be in sliding contact with a radially inner portion of the inner side of the wheel mounting flange 58 of the wheel hub 52, via a predetermined interference over its whole periphery.

The middle dust lip 56 is adapted to be in sliding contact with a curved surface 60 at a connection between the inner side surface and the outer circumferential surface of the wheel hub 52. Its tip is directed in a direction opposite to the inside space 59 of the bearing via a predetermined interference over its whole periphery.

The grease lip 57 is arranged nearest to the inside space 59 of the bearing. It forms a labyrinth gap 61 under a condition where its tip is directed to the inside space 59. Since the labyrinth gap 61 is positioned innermost of the outer end opening of the inside space 59, the grease filled within the inside space 59 tends to be gathered radially outwardly by a centrifugal force caused by rotation of the wheel hub 52.

That is, when the wheel hub 52 rotates, balls 62 and the cage 63 rotate at a speed about half the rotational speed of the wheel hub 52. This rotation is transmitted to the grease. As a result, the grease tends to be gathered radially outwardly of the inside space 59. Thus, a condition exists where grease is scarcely present at the radially inner position near the labyrinth gap 61. Accordingly, the arrangement of the grease lip 57 so that it extends radially inwardly toward the inside space 59 prevents the grease from leaking out from the inside space 59 through the labyrinth gap 61. Thus, this keeps the necessary sealing performance, to reduce the rotational resistance of the wheel hub 52, and to improve the traveling performance of the vehicle. Patent Document 1: Japanese Laid-open Patent Publication No. 222145/2003.

In the prior art seal 50, grease leakage can be effectively prevented by the labyrinth gap 61 of the grease lip 57. The entering of rain water or dusts into the bearing from the outside can be also prevented by the side lip 55 and dust lip 56 extending radially outwardly toward their tips. Under the circumstances, it has been found that the sealing performance can be improved by increasing the length of the radially outermost side lip 55. The longer the length of the seal lip, the more adequate elasticity can be obtained. Thus, the side lip 55 can slidingly contact the radially inward portion of the wheel mounting flange 58 at its inner side over its whole periphery, via a uniform interference.

However, the longer the length of the side lip 55, the larger its outer diameter. Thus, a press-fitting tool (not shown) tends to interfere with the side lip 55 and damage it when the seal 50 is press-fit into the outer ring 51. Accordingly, in order to avoid such an interference of the press-fitting tool with the side lip 55, a simple press-fitting tool has been adopted with thin nails to press-fit an end face of the seal 50 that can be inserted into a narrow annular space around the side lip 55. However, such a press-fitting with thin nails cannot apply sufficient press-fitting force onto the end face of the seal 50. Thus, it is possible the seal would be pushed out from the outer member when a pressure in the bearing is increased by rise in bearing temperature.

### SUMMARY

It is, therefore, an object of the present disclosure to provide a vehicle wheel bearing apparatus that can extend its operating life by improving the sealability and durability of its seals.

In order to achieve the object, a vehicle wheel bearing apparatus comprises an outer member formed, on its outer circumference, with a body mounting flange to be mounted on a body of a vehicle. Its inner circumference includes double row outer raceway surfaces. An inner member includes a wheel hub and an inner ring or an outer joint member of a constant velocity universal joint. The wheel hub is formed on one end with a wheel mounting flange. Its outer circumference includes one inner raceway surface opposing one of the double row outer raceway surfaces. A cylindrical portion axially extends from the inner raceway surface. The inner ring or an outer joint member of a constant velocity universal joint is press-fit onto the cylindrical portion of the wheel hub. Its outer circumference has the other inner raceway surface opposing the other of the double row outer raceway surfaces. Double row rolling element groups are freely rollably contained between the outer and inner raceway surfaces of the outer and inner member. A seal is adapted to be mounted within an outer side end of the outer member. The seal has an integrally formed side lip extending radially outwardly toward its tip. It is in sliding contact with an inner side base portion of the wheel mounting flange via a predetermined interference. An initial maximum diameter of the side lip is formed with a smaller diameter than that of a maximum diameter of the seal. A difference between the initial maximum diameter of the side lip and the maximum diameter of the seal is set at least 1 mm on one side (i.e. radius).

The wheel hub is formed on its one end with a wheel mounting flange and on its outer circumference with one inner raceway surface. The seal has an integrally formed side lip extending radially outwardly toward its tip and in sliding contact with an inner side base portion of the wheel mounting flange, via a predetermined interference. An initial maximum diameter of the side lip is formed with a smaller diameter than that of a maximum diameter of the seal. A difference between the initial maximum diameter of the side lip and the maximum diameter of the seal is set at least 1 mm on one side (i.e. radius). Thus, it is possible to provide a vehicle wheel bearing apparatus that enables the seal to be stably press-fit into the outer member without interfering with the side lip. It keeps a predetermined resisting force against the push out force. Thus, it improves the sealability and durability of the seal and extends the life of the bearing apparatus.

It is preferable that a pitch circle diameter of the double row ball group of the outer side is larger than a pitch circle diameter of the double row ball group of the inner side. This makes it possible to increase the bearing rigidity of the outer side as compared with that of the inner side. Thus, this extends the life of the bearing apparatus as well as keeping a stable sealability of the bearing for a long term with the pushing-out of the outer side seal being further effectively prevented due to the difference in the pitch circle diameters.

It is also preferable that the seal further comprises a dust lip arranged radially inside of the side lip. The lip extends radially outwardly toward its tip, has a length shorter than that of the side lip, and is in sliding contact with the base portion via a predetermined interference. A grease lip forms a radial lip under a condition where its tip is directed toward the inside of the bearing. This makes it possible to prevent leakage of grease and the entering of rain water or dusts into the bearing from the outside.

The vehicle wheel bearing apparatus has an outer member formed, on its outer circumference, with a body mounting flange to be mounted on a body of a vehicle. Its inner circumference includes double row outer raceway surfaces. An inner member includes a wheel hub and an inner ring or an outer joint member of a constant velocity universal joint. The wheel hub is formed on its one end with a wheel mounting flange. Its outer circumference includes one inner raceway surface opposing one of the double row outer raceway surfaces. A cylindrical portion axially extends from the inner raceway surface. The inner ring or an outer joint member of the constant velocity universal joint is press-fit onto the cylindrical portion of the wheel hub. Its outer circumference includes the other inner raceway surface opposing the other of the double row outer raceway surfaces. Double row rolling element groups are freely rollably contained between the outer and inner raceway surfaces of the outer and inner members. A seal is adapted to be mounted within an outer side end of the outer member. The seal has an integrally formed side lip that extends radially outwardly toward its tip and is in sliding contact with an inner side base portion of the wheel mounting flange, via a predetermined interference. An initial maximum diameter of the side lip is formed with a smaller diameter than that of a maximum diameter of the seal. A difference between the initial maximum diameter of the side lip and the maximum diameter of the seal is set at least 1 mm on one side (i.e. radius). Thus, it is possible to provide a vehicle wheel bearing apparatus that enables the seal to stably press-fit into the outer member without interfering with the side lip, to keep a predetermined resisting force against the pushed-out force, to improve the sealability and durability of the seal and thus to extend the life of the bearing apparatus.

A vehicle wheel bearing apparatus comprises an outer member formed, on its outer circumference, with a body mounting flange to be mounted on a body of a vehicle. Its inner circumference includes double row outer raceway surfaces. An inner member includes a wheel hub and an inner ring or an outer joint member of a constant velocity universal joint. The wheel hub is formed on its one end with a wheel mounting flange. Its outer circumference includes one inner raceway surface opposing one of the double row outer raceway surfaces. A cylindrical portion axially extends from the inner raceway surface. The inner ring or an outer joint member of the constant velocity universal joint is press-fit onto the cylindrical portion of the wheel hub. Its outer circumference has the other inner raceway surface opposing the other of the double row outer raceway surfaces. Double row rolling element groups are freely rollably contained between the outer and inner raceway surfaces of the outer and inner member. A seal is adapted to be mounted within an outer side end of the outer member. The seal has an integrally formed side lip, dust lip and grease lip. The side lip and dust lip are adapted to be in sliding contact with a base having a circular arc cross-section at the inner side of the wheel mounting flange, via a predetermined interference. The grease lip forms a radial lip with its tip directed toward the inside of the bearing. An initial maximum diameter of the side lip is formed with a smaller diameter than that of a maximum diameter of the seal. A difference between the initial maximum diameter of the side lip and the maximum diameter of the seal is set at least 1 mm on one side (i.e. radius).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal section view of one preferred embodiment of the vehicle wheel bearing apparatus.

FIG. 2 is a partially enlarged view of FIG. 1.

FIG. 3 is an explanatory view of a method of press-fitting the seal.

FIG. 4 is partially enlarged view of a seal of a prior art wheel bearing apparatus.

### DETAILED DESCRIPTION

One preferred embodiments of the present disclosure will be hereinafter described with reference to the drawings.

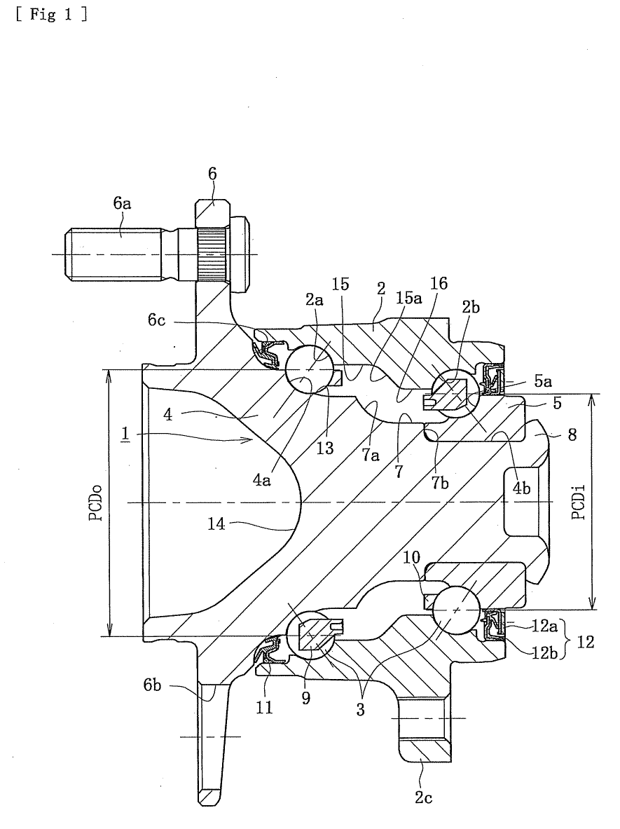

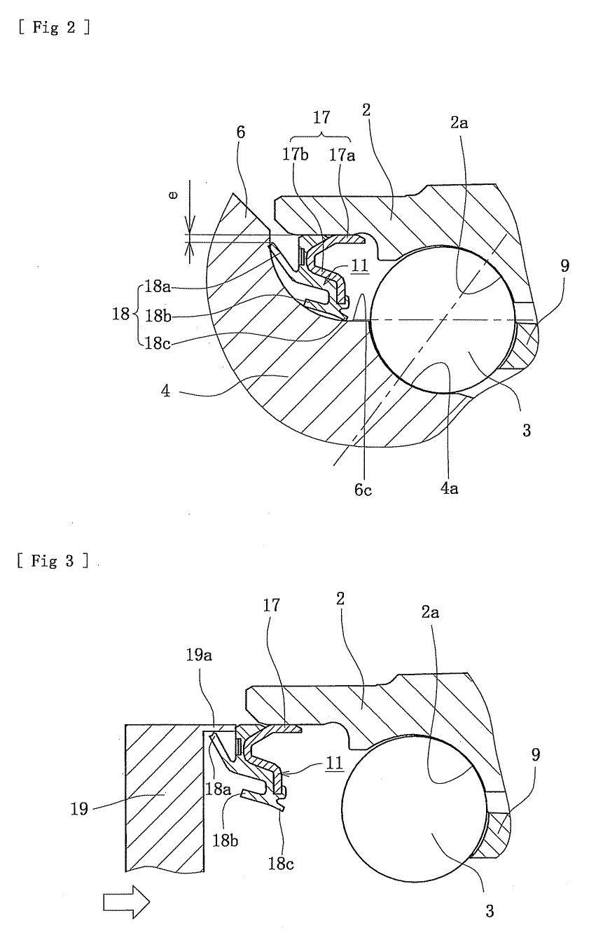

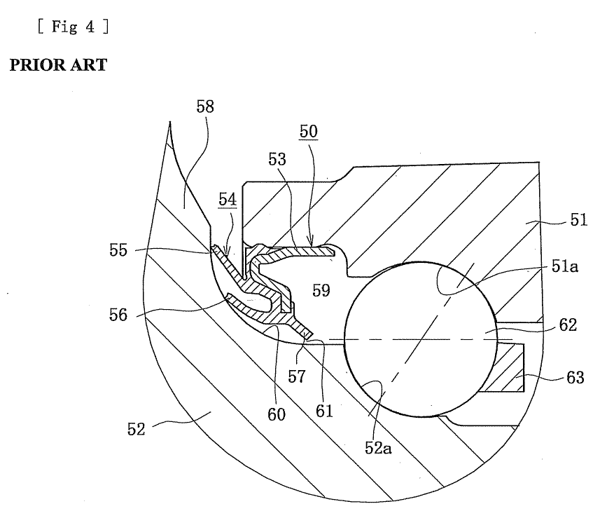

FIG. 1 is a longitudinal section view of one preferred embodiment of the vehicle wheel bearing apparatus. FIG. 2 is a partially enlarged view of FIG. 1. FIG. 3 is an explanatory view of a method for press-fitting the seal. In descriptions in this specification, the term “out side” defines a side that is positioned outside of a vehicle body (left-hand side in drawings). The term “inner side” defines a side that is positioned inside of a vehicle body (right-hand side in drawings) when the bearing apparatus is mounted on the vehicle body.

The vehicle wheel bearing apparatus shown in FIG. 1 is a third generation type used for a driven wheel. It has an inner member 1, an outer member 2, and double row rolling element (ball) groups 3, 3 rollably contained between the inner and outer members 1, 2. The inner member 1 includes the wheel hub 4 and an inner ring 5 press-fit on the wheel hub 4, via a predetermined interference.

The wheel hub 4 is integrally formed with a wheel mounting flange 6 at its one end. One (outer side) inner raceway surface 4a is on its outer circumference. A cylindrical portion 4b extends from the inner raceway surface 4a through a shaft-shaped portion 7. Hub bolts 6a are arranged on the wheel mounting flange 6 equidistantly along the periphery of the wheel mounting flange 6. Circular apertures 6b are formed between the hub bolts 6a. These circular apertures 6b contribute not only to the reduction of weight of the bearing apparatus but to the passage of any fastening tool used to assemble and disassemble of the bearing apparatus.

The inner ring 5 is formed, on its outer circumference, with the other (inner side) inner raceway surface 5a. It is adapted to be press fit onto the cylindrical portion 4b of the wheel hub 4 to form a double row angular contact ball bearing of the back-to-back duplex type. It is axially secured by a caulked portion 8 formed by plastically deforming the end of the cylindrical portion 4b. The inner ring 5 and balls 3 are made of high carbon chrome steel such as SUJ2. They are hardened to their core by dip quenching to have a surface hardness of 58˜34 HRC.

The wheel hub 4 is made of medium carbon steel including carbon of 0.40˜0.80% by weight such as S53C. It is hardened by high frequency induction quenching so that a region including the inner raceway surface 4a from the inner side base 6c of the wheel mounting flange 6 to the cylindrical portion 4b is hardened to have a surface hardness of 58˜64 HRC. The caulked portion 8 surface hardness remains as is after forging. Accordingly, the wheel mounting flange 6 has a sufficient mechanical strength against applied rotary bending loads. The anti-fretting strength of the cylindrical portion 4b at a region press fit by the inner ring 5 can be improved. The plastically deforming working of the caulked portion 8 can be also carried out without any micro crack during the caulking process.

The outer member 2 is integrally formed, on its outer circumference, with a body mounting flange 2c to be mounted on a knuckle (not shown) of a vehicle. Its inner circumference includes an outer side outer raceway surface 2a opposite to the inner raceway surface 4a of the wheel hub 4 and an inner side outer raceway surface 2b opposite to the inner raceway surface 5a of the inner ring 5. Double row ball groups 3, 3 are contained between these outer and inner raceway surfaces and are rollably held by cages 9, 10.

The outer member 2 is made of medium carbon steel including carbon of 0.40˜0.80% by weight such as S53C. The double row outer raceway surfaces 2a, 2b are hardened by high frequency induction quenching to have a surface hardness of 58˜64 HRC. Seals 11, 12 are mounted within annular opening spaces formed between the outer member 2 and the inner member 1. The inner side seal 12 forms a so-called “pack seal”. It includes a slinger 12a and a sealing plate 12b and prevents the leakage of grease contained in the bearing and the entering of rain water and dusts into the bearing from the outside. Although the structure shown here is a double row angular contact ball bearing using balls as rolling elements 3, a double row tapered roller bearing using tapered rollers as rolling elements 3 may be used. In addition, the wheel bearing apparatus of the present disclosure is not limited to the bearing structure of a third generation and may be applied to bearing structures of the fourth generation where the inner raceway surfaces are directly formed on the wheel hub.

A pitch circle diameter PCDo of the outer side ball group 3 is set larger than a pitch circle diameter PCDi of the inner side ball group 3. Due to a difference in the pitch circle diameters PCDi and PCDo, despite the ball having same size, the number of balls in the ball group 3 in the outer side is larger than the number of balls of the ball group 3 in the inner side. This makes it possible to increase the rigidity of the outer side bearing as compared with that of inner side bearing while effectively utilizing the bearing space and thus improving the life of bearing.

The wheel hub 4 has an outline configuration from a groove bottom of the inner raceway surface 4a to the cylindrical portion 4b through a counter portion 13, a shaft-shaped portion 7 axially extending from the counter portion 13, via stepped portion 7a having a circular arc cross-section, and a shoulder 7b abutting against the inner ring 5. A conical recess 14 is formed at an outer side end portion of the wheel hub 4. The depth of the recess 14 extends to near the bottom of the outer side inner raceway surface 4a of the wheel hub 4. Thus, the outer side end portion of the wheel hub 4 has a substantially constant wall thickness. Due to the difference in the pitch circle diameters PCDo and PCDi, the inner raceway surface 4a of the wheel hub 4 is formed so that it has a larger diameter than that of the inner raceway surface 5a of the inner ring 5. An outer diameter of the shaft-shaped portion 7 is substantially the same as a groove bottom diameter of the inner raceway surface 5a. This solves the antinomic problems of reducing the weight and size of the bearing apparatus while increasing the rigidity of the bearing apparatus.

In the outer member 2, due to the difference in the pitch circle diameters PCDo, PCDi, the diameter of the outer side outer raceway surface 2a is larger than that of the inner side outer raceway surface 2b. The outer side outer raceway surface 2a continues to the inner side outer raceway surface 2b via a cylindrical shoulder 15, a stepped portion 15a and a shoulder 16 of a smaller diameter size. The inner diameter of the bottom of the inner side outer raceway surface 2b is set so that it has substantially the same diameter as the inner diameter of the shoulder 15 of a larger diameter side.

As shown in the enlarged view of FIG. 2, the outer side seal 11 includes a metal core 17 and a sealing member 18 integrally adhered to the metal core 17, via vulcanized adhesion. The metal core 17 is made of austenitic-stainless steel sheet (JIS SUS 304 etc.) or preserved cold rolled steel sheet (JIS SPCC etc.). It is formed with a generally C-shaped cross-section by a pressing process. The metal core 17 includes a cylindrical fitting portion 17a adapted to be fit into an inner circumference of the end of the outer member 2. An inside portion 17b of the metal core 17 is bent and extends radially inward.

The sealing member 18 is made of synthetic rubber such as nitrile rubber. It is secured on the metal core 17 in a region from a portion of the fitting portion 17a to an inner end portion of the inside portion 17b. The sealing member 18 includes a side lip 18a, a dust lip 18b and a grease lip 18c. The base portion 6c of the inner side of the wheel mounting flange 6 is formed with a circular arc cross-section. The side lip 18a and the dust lip 18b have different length than each other and extend radially outwardly toward their tips. They are adapted to be in sliding contacted with the base portion 6c over their entire peripheries via a predetermined interference. The grease lip 18c forms a radial lip with its tip extending toward an inside of the bearing. It is in sliding contact with the outer circumferential surface of the base portion 6c via a predetermined interference.

According to the preferred embodiment, a maximum diameter of the side lip 18a is formed so that it is smaller than the diameter of the seal 11. The difference “e” in maximum diameters is set at least 1 mm on one side (i.e. radius). This makes it possible to press-fit the seal 11 into the outer member 2 by a press-fitting tool 19 without any interference of the tool 19 with the side lip 18a. The press-fitting tool 19 is integrally formed on its one end with annular pressing portion 19a. The wall thickness of the pressing portion 19a is set at least 1 mm.

It is known that internal bearing pressure rises usually to 0.2 MPa due to the temperature rise during travel of the vehicle. In addition, when the maximum internal pressure is set at 0.3 MPa (safety factor: 1.5), it is necessary that the seal 11 should be press-fit at a predetermined pressing force (push-out resisting force) in order to prevent the seal 11 from being pushed-out even though such an internal pressure would be caused. It is appreciated that a load of about 2,000 kgf will be applied to the seal 11 of this kind having an outer diameter of 60 mm. Accordingly it is necessary to set the pressing force of the seal 11 at least about 600 kgf so it is able to resist the push out load. That is, assuming that the allowable bearing pressure of the sealing member 18 is 3 kgf/mm², the wall thickness of the pressing portion 19a is set at least 1 mm.

The maximum diameter of the side lip 18a is formed at least 1 mm smaller than that of the seal 11 on one side (i.e. radius). This difference “e” in radius makes it possible for the seal 11 to be stably press-fit into the outer member 2 by the press-fitting tool 19 without interfering with the side lip 18a. A predetermined resisting force against the push out force and a desired sealing performance are assured. The sealability and durability of the seal 11 are improved. This provides a vehicle wheel bearing apparatus with an improved life of the bearing. In the wheel bearing apparatus effectively utilizing the bearing space and having the outer side pitch circle diameter PCDo of bearing group 3 larger than the inner side pitch circle diameter PCDi, it is inevitable to increase the diameter of the outer side seal 11 and thus increases the push out force applied to the outer side seal 11. Thus, effects obtained by adopting the seal having a simple structure and solving such a problem are tremendous.

The present disclosure has been described with reference to the preferred embodiment. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents.

The vehicle wheel bearing apparatus of the present disclosure can be applied to any of the bearing apparatus of the third or fourth generation irrespective of the driving wheel or the driven wheel.

What is claimed is:

1. A vehicle wheel bearing apparatus comprising:
an outer member formed, on its outer circumference, with a body mounting flange to be mounted on a body of a vehicle and on its inner circumference with double row outer raceway surfaces;
an inner member including a wheel hub and an inner ring or an outer joint member of a constant velocity universal joint, the wheel hub is formed on its one end with a wheel mounting flange, its outer circumference includes one inner raceway surface opposing one of the double row outer raceway surfaces, a cylindrical portion axially extends from the inner raceway surface, and the inner ring or an outer joint member of the constant velocity universal joint is press-fit onto the cylindrical portion of the wheel hub and its outer circumference includes the other inner raceway surface opposing the other of the double row outer raceway surfaces;
double row rolling element groups are freely rollably contained between the outer and inner raceway surfaces of the outer and inner members; and
seal is adapted to be mounted within an outer side end of the outer member, the seal has an integrally formed side lip extending radially outwardly toward its tip and in sliding contact with an inner side base portion of the wheel mounting flange, via a predetermined interference, an initial maximum diameter of the side lip is formed with a smaller diameter than that of a maximum diameter of the seal and a difference between the initial maximum diameter of the side lip and the maximum diameter of the seal is set at least 1 mm on one side.

2. The vehicle wheel bearing apparatus of claim 1 wherein a pitch circle diameter of the double row ball group of the outer side is larger than a pitch circle diameter of the double row ball group of the inner side.

3. The vehicle wheel bearing apparatus of claim 1 wherein the seal further comprises a dust lip arranged radially inside of the side lip, extending radially outwardly toward its tip, and has a length shorter than that of the side lip, and in sliding contact with the base portion via a predetermined interference, and a grease lip forming a radial lip under a condition where its tip is directed toward the inside of the bearing.
